(19) United States
(12) Patent Application Publication
(10) Pub. No.: US 2008/0281721 A1
(43) Pub. Date: Nov. 13, 2008

(54) SYSTEM AND METHOD FOR FAMILY-ORIENTED ACCOUNT MANAGEMENT

(76) Inventor: Anton Robert SIMUNOVIC, Ontario (CA)

Correspondence Address: MCDERMOTT WILL & EMERY LLP, 600 13TH STREET, N.W., WASHINGTON, DC, 20005-3096, US

(21) Appl. No.: 12/116,725

(22) Filed: May 7, 2008

Related U.S. Application Data
(60) Provisional application No. 60/924,258, filed on May 7, 2007.

(51) Int. Cl. G06Q 40/00; G06Q 30/00

(52) U.S. Cl. 705/26; 705/35; 705/39; 705/42

(57) ABSTRACT

Systems and methods for facilitating online money management are provided. Parents may create accounts for themselves and their children. The children's accounts include savings, sharing, and spending sub-accounts. The parent's account may also include savings, sharing, and spending sub-accounts. A percentage of profit and/or revenue generated by the accounts are provided back to the children or their parents.

### CROSS REFERENCE TO RELATED APPLICATIONS

This application claims priority from Provisional U.S. Patent Application No. 60/924,258 entitled “System and Method for Family-Oriented Account Management”, which was filed on May 7, 2007, the entire disclosures of which is incorporated herein by reference.

### FIELD OF THE INVENTION

This application relates generally to online money-management for children and their families, and more particularly to financially transparent systems and methods which allow for profit and/or revenue sharing, as well as first-hand experience for children to save, spend, and share their earned or gifted money.

### BACKGROUND OF THE INVENTION

All parents aspire to have their children grow into financially and socially responsible adults. However, many studies have suggested that this goal is not being attained. Personal bankruptcies in people between the ages of 18 and 24 have increased dramatically, according to some studies. Other studies have shown a strong desire by children to learn more about money management, though only a small percentage of children are able to obtain this knowledge from their parents/guardians.

Parents have given allowances to children for many years. Often in exchange for good behavior, completing chores, good grades etc. However, these conventional methods of compensating children do little to teach children how to be socially and financially responsible. Rather, they are often used to alter a child's short-term behavior which can lead to unintended, long-term consequences. As well, these techniques provide no structured methodology for teaching children about money, its management, or in enabling children to save, spend, or share charitably with or without parental approval.

Children are learning to use computers and the internet at younger ages. It would be desirable to have a system and method which experientially taught and enabled children to manage money through saving, spending, and sharing opportunities in a computer-based environment.

### SUMMARY OF THE INVENTION

Accordingly, the present application is directed to an online money management system and method where children can earn money, experientially learn money management skills, and cultivate their social conscience. The systems and methods provide a convenient, easy, safe, and controlled environment that teaches financial responsibility, while imparting family values through financial decision-making and tangible giving.

In accordance with some embodiments, a computer-implemented method for facilitating online money management is provided. The method may include the steps of receiving, at a host device, a request by a parent or guardian to create a parent account and receiving a request to create one or more child accounts linked to the parent account, each child account being subdivided into three or more sub-accounts. Money deposited into each child account may be allocated to any one of, or each of the three or more sub-accounts, according to percentage allocation provided by the parent/guardian or the child. This system and method can take the form of real or virtual money deposited into the child accounts.

In accordance with some embodiments, a system for online money management is provided which comprises a parental control module configured to create a parent account and one or more child accounts and the administering of the child accounts, a child account management module providing an interface to each of said one or more child accounts, and a financial management module allowing for the earning of money, processing deposits, transfers and withdrawals for said one or more child accounts. Each child account may include a savings sub-account, a sharing sub-account, and a spending sub-account.

### BRIEF DESCRIPTION OF THE DRAWINGS

FIG. 1 depicts a simplified block diagram of a family money management system, in accordance with various disclosed embodiments.

FIG. 2 depicts a more detailed block diagram of a family money management system.

FIGS. 3-9 are screenshots presenting various aspects of a user interface provided by the family money management system.

### DETAILED DESCRIPTION

The systems and methods of the present application provide for online money management, wherein children learn money management skills and cultivate their social conscience. These systems and methods provide a convenient, easy, safe, and controlled environment that teaches financial responsibility, while imparting family values in a child through financial decision-making and tangible giving. Children are experientially empowered to manage “their” money, making it real, visual, and fun. Children are provided with opportunities to earn money from family and friends in many ways, including a traditional allowance, an allowance received in exchange for completed chores, through the completion of special projects and/or tasks, from the receipt of gifts and in other ways. Earned money is then allocated by the parent/guardian or child and deposited in real-terms or virtual terms to a child's save, spend, and share accounts. Through their save accounts, children learn about the value of investing, investment options and can make safe investments in real life or virtually. Spend accounts allow for real-time consumption of products or services while teaching the importance of smart spending and delayed gratification. Share accounts allow kids to make tangible donations with their own money or through company profit and/or revenue sharing, toward causes of interest most important to them. Parental controls provide comfort to parents knowing that they have complete control of their children's online financial and social experience.

The systems and methods described herein provide a financially transparent model which engenders trust, promotes financial education, encourages giving, and provides sound saving and spending opportunities. The system may be configured to transparently report all profits and/or revenues earned, and to provide a portion of that profit and/or revenue directly back to subscribing families or family members.

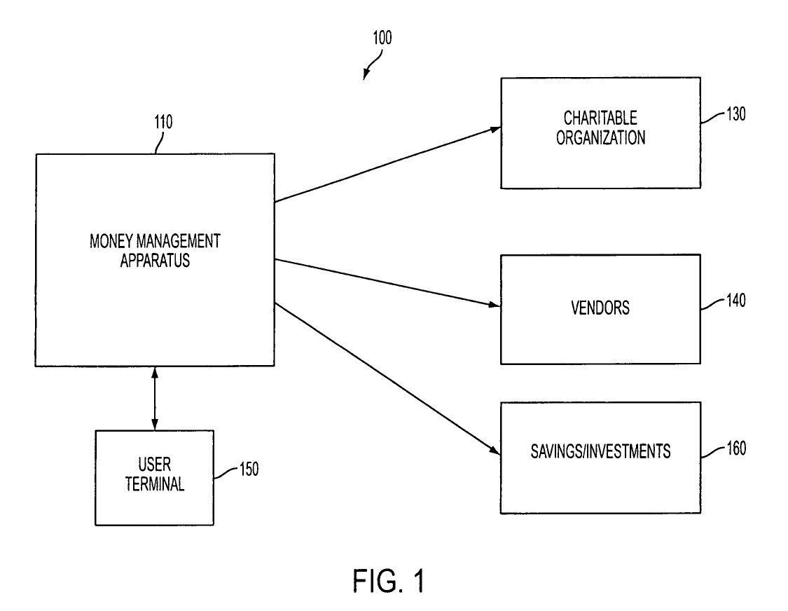

FIG. 1 is a simplified block diagram depicting the overall configuration of a family money management system 100. Family money management system 100 may be implemented on any electronic device, such as a server, personal computer, wireless phone etc. The money management system 100 may include a money management apparatus 110 which may be communicatively coupled to one or more charitable organizations 130 and one or more vendors 140. User terminals 150 are also communicatively coupled to the money management apparatus 110, enabling users such as parents and children to access the system.

A parent or guardian may request a new account with system 100 via the money management apparatus 110. When a parent/guardian requests a new account, a number of steps may occur. First, an access account may be created for the parent/guardian. Child access accounts may also be created for one or more of the parent's children upon request by the parent. In accordance with some embodiments, when a parent opens a new parent access account, the parent may provide financial information used to provide money to fund their children's spending and/or saving and/or sharing. For example, parents may provide a credit card number, a PayPal account number, existing bank account numbers and routing numbers, and/or any account information for any other account which would allow for the electronic or offline transfer of funds. In some embodiments, account information may be provided by the parent at a time other than at the time of sign-up. In some embodiments the money management system may act as a “virtual” bank. As children earn money, the system may track all earnings and make virtual deposits into the child's account, which are in turn allocated to the child's spending, sharing and savings account. The system may track all spending, saving and sharing decisions made by the child, which may require approval from the parent or guardian. When a child needs “real” money to effect spending, sharing, or saving decisions they've made, the system may charge or deduct the funds from the parent by way of the account information they provided. The child's account may then be virtually debited, thereby reconciling the accounts.

In some embodiments, family money management system 100 may link to one or more financial institutions. In accordance with these embodiments, when a parent opens an access account, a bank account may also be opened with one of the financial institution partners. The bank account may be any bank account, such as a savings account, checking account, money market account, etc. This bank account may be configured to hold all funds deposited, transferred and withdrawn for each child. The children may be considered authorized user's of the parent's bank account. As children earn money, the system may track all earnings and make “real” deposits into the parent's account with reconciliation back to the child's saving, spending and sharing accounts. The system may track all spending, saving and sharing decisions made by the child, which may require approval from the parent or guardian. When a child spends, shares, or saves money through their own account, the system may charge or deduct funds from the parent's account or through other account information they provided. The system will then virtually debit the child's account, ensuring account reconciliation.

Money management apparatus 110 also includes tools for interfacing with charitable organizations 130, vendors 140, and saving or investment opportunities 160. More particularly, money management apparatus 110 provides an interface that enables parents and their children to manage money by making charitable contributions as individuals or as part of a larger community supporting a given cause, in making online and/or offline purchases, and in making saving or investment decisions with available earnings. Children may spend earned funds by purchasing gift cards from the vendors 140. In some embodiments, vendors 140 provide full e-commerce capability, enabling the child to purchase goods and services directly through the money management system. Spending may also be accomplished by loading earned money onto pre-paid debit cards. This enables children to purchase goods and/or services offline as well as online.

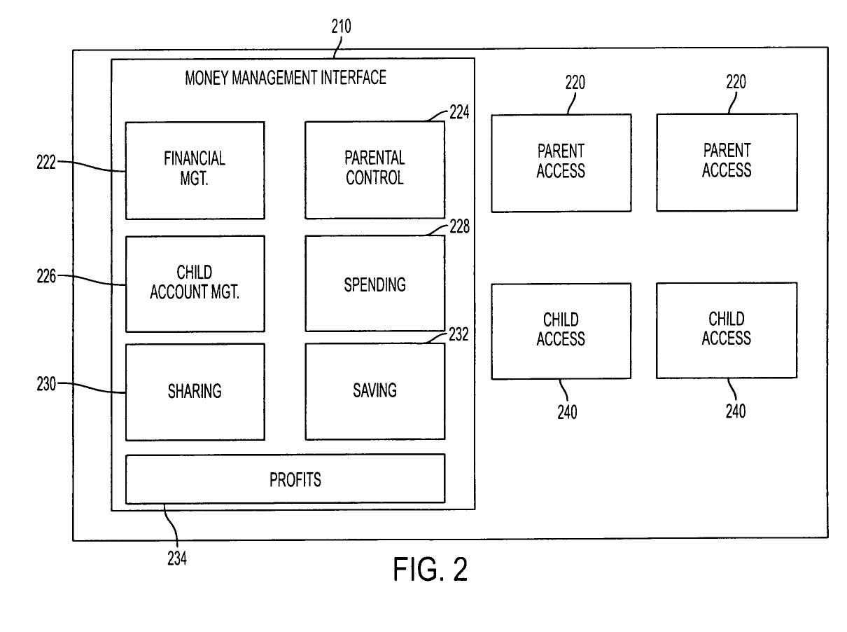

FIG. 2 depicts a money management apparatus 110 in greater detail. Money management apparatus 110 may include a management interface 210, one or more parent access accounts 220, and one or more child access accounts 240. Money management interface 210 may include a plurality of management modules, including financial management module 222, parental control module 224, child account management module 226, spending module 228, sharing partner module 230, savings module 232, and profits/revenue module 234.

Parent access accounts 220 may be configured to provide an interface wherein parents can manage their accounts and supervise activities associated with their children's accounts. This may include, for example, enabling a parent to authorize a child's spending, saving, and sharing. Child access accounts 240 may be configured to provide an interface which gives each child a view of the money they have earned.

Financial management module 222 may be configured to process all financial transactions. As described above, in accordance with some embodiments, the money management system may provide virtual accounts for children, which may be divided into spend, share, and save accounts. While the funds are presented to the child via a virtual view, when the child wishes to make an actual purchase, investment or charitable contribution, financial management module 222 may be configured to facilitate a transfer of funds from the parent's financial account which was previously configured. That is, financial management module 222 may be configured to store the account information provided by the parent, and debit the provided account when a child makes an authorized purchase, investment or contribution.

Children may earn money in a variety of manners. For example, some parents may provide a child with an allowance under a pre-determined schedule (i.e., weekly, monthly, etc.). Some parents may provide an allowance based on whether or not a child completes their assigned chores. Children may also earn money by performing special projects from time-to-time, or as gifts (birthdays, special events, holidays etc.) from family members and friends. Financial management module 222 may also be configured to tag sources and uses of funds so that the child is able to clearly track where their money has come from and where it goes. The money may then be virtually deposited and presented to the child via the child's access account, enabling the child to view their earnings. Moreover, in those embodiments where a parent has opened a bank account with a financial institution partner, financial management module 222 may be configured to reconcile deposits, transfers and withdrawals to and from the bank account.

Parental control module 224 enables a parent to have oversight over their children's accounts. The parent control module 224 may be configured to enable a parent to create accounts for their children, decide how their children's funds should be allocated to each of the children's sub-accounts, and to review, authorize and administer children's spending, sharing, and savings. Child account management module 226 provides tools which enable a child to exercise some control over their account. For example, child account management module 226 provides an interface which enables a child to view their funds, make purchases, make saving and investment decisions, and/or choose charities for making donations to. Some or all of these activities may require parental approval. Child account management module 226 may also provide an interface which enables the child to view a schedule of when, how much, from whom and in what way, money can be earned.

Spending module 228 may be provided to present an interface to one or more trusted on-line vendors. In some embodiments, the online vendors allow children to purchase gift cards. In other embodiments, the vendors provide full e-commerce functionality through the money management system. In still other embodiments, children may be provided with prepaid debit cards and/or debit and/or ATM cards for making purchases from vendors other than the online vendors. Sharing module 230 may provide an interface for making donations to one or more charitable partners. Sharing module 230 may also enable children to collectively pool their sharing account funds or establish, lead and/or join a particular cause of interest which other members may donate to.

Savings module 232 may be provided to enable a child to explore savings and investment options. For example, the savings module may be configured to provide options for how money is best saved and invested. This may include, presenting different saving account options with differing terms and interest rates for example, savings accounts, money market funds, certificates of deposits, and/or other investment opportunities. Investment options may also include government bonds, equity and equity linked securities, bond and bond-linked securities, mutual funds etc. In some embodiments, the savings module 232 will invest real money, through decisions directed by the child, and approved by the parent following all applicable laws and regulations. In other embodiments, the savings module 232 will be virtual in that children will choose and make investment decisions, approved by the parent following all applicable laws and regulations, and earn “returns” on their investments, reflective of the market, though paid to the children by the parent. Profits/Revenue module 234 may be configured to transparently track the profits and revenue earned by the system. Profits may be earned in a variety of ways, such as, for example, via subscriber fees, fees paid by system partners such as banks or vendors, and/or any other profit generation means. Profits/Revenue module 234 may be further configured to report profits and revenue to the parents and/or children, and to provide a percentage of the profits and/or revenue back to the subscribing families or family members. In some embodiments, families or its members may receive profit or revenue sharing tied directly to their account transactions. In other embodiments, profits and/or revenue may be shared equally or proportionately to all subscribing families or members.

As described above, child accounts 240 may be partitioned into a savings account, a spending account, and a sharing account. In some embodiments, parent accounts may also be partitioned into savings, spending, and sharing accounts. Savings accounts encourage online saving and safe investing. Share accounts allow children to direct money allocated by the parent and/or child for sharing to be donated to charities of the child's choice. In accordance with some embodiments, a percentage of the profit and/or revenue made by the money management system is provided back to the children for sharing. Spend accounts provide a private and secure channel for kids to conduct smart online commerce.

Parents may establish allocation levels for each of their child's three accounts. For example, assuming allocations of 80% saving, 5% sharing, and 15% spending would suggest that for every $100 a child earns, $80 will be allocated to savings, $5 to sharing, and $15 to spending According to some embodiments, a child may suggest an allocation, and the parent can then approve or disapprove of the allocation. In addition to money allocated to sharing accounts by parents and children, the system may also provide a percentage of any profit and/or revenue generated by the parent or child accounts back to the child's share account. Profits and/or revenue may also be distributed to children on a scheduled basis as long as the account remains open. Additionally, parents and children can agree on what percentage of the child's earned money will be allocated to their sharing account. In some embodiments, profits and/or revenue made by the money management system may also be provided to the child's spending or saving accounts. In still other embodiments, profit and/or revenue made by the money management system may be provided to any one or all of a parent's spend, save or share accounts should the parent choose to personally open these accounts for themselves. While the parent retains complete control over all settings (e.g., allocations, amounts, purchases, etc.), the child feels empowered by initiating spending, saving and sharing decisions, learning from visual and descriptive information flows, and by being an active member of the decision process.

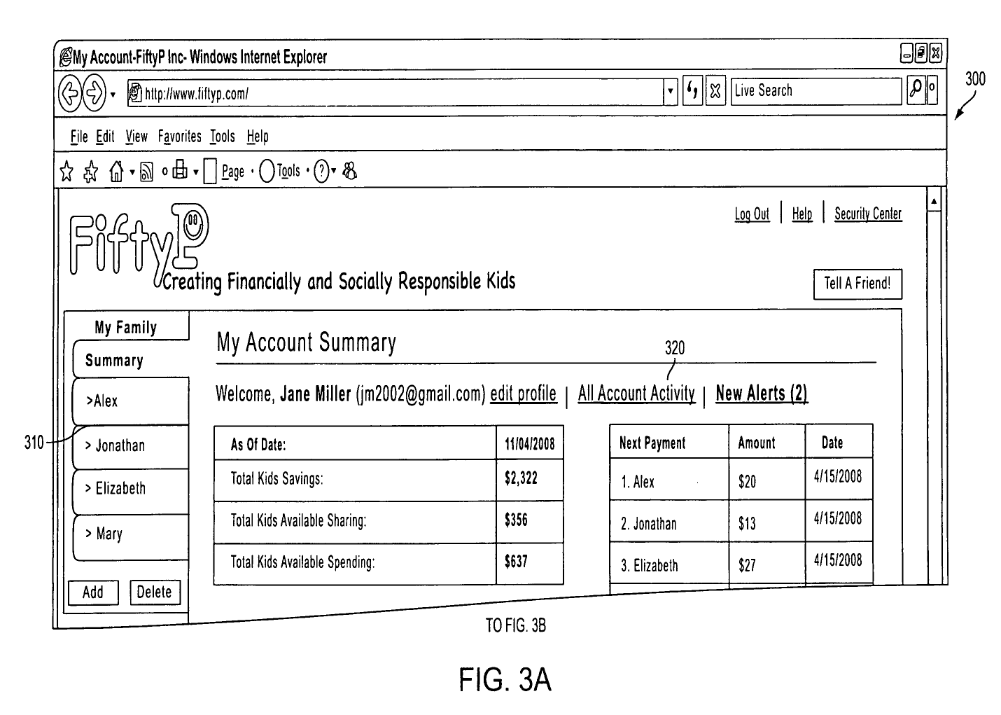

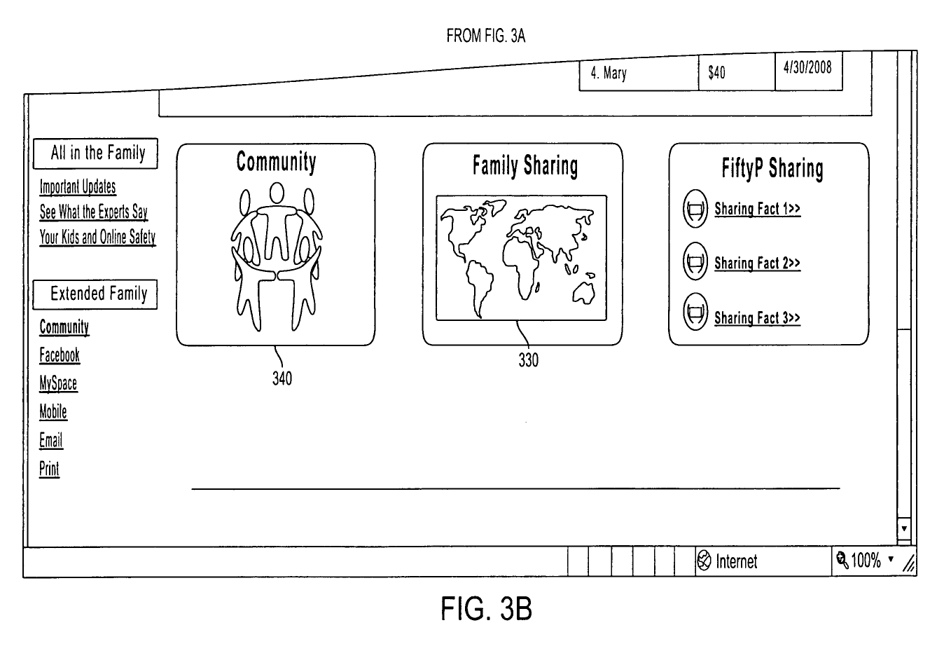

FIG. 3 depicts an example of a parent access account interface 300. An account summary enables a parent to see, at a glance, an overview of their family's accounts. For example, the account summary may present the totals for all of their children's sharing, saving, and spending accounts. Additionally, the next payments due to each child may be displayed, including the amount owed and the date to be paid. Parents may also view detailed information regarding each child's account by selecting the child's name, as depicted at 310.

Account activity information is available to the parent, as depicted at 320, by selecting “All Account Activity”. Because sharing is an important part of teaching a child to manage money and to catalyze social responsibility, the parent access account interface may present a consolidated view of the family's sharing, as depicted at 330. Selecting the link at 330 may direct the parent to detailed information about the family's sharing including, for example, amounts shared, particular charities to which donations were made, impact of donation made, locations to which donations were made, etc. Parent access account interface 300 may also include a link 340 to a community section, which enables the parents to engage in social networking with other members. These online communities will broadly engage in topics of financial and social responsibility within families and the individual.

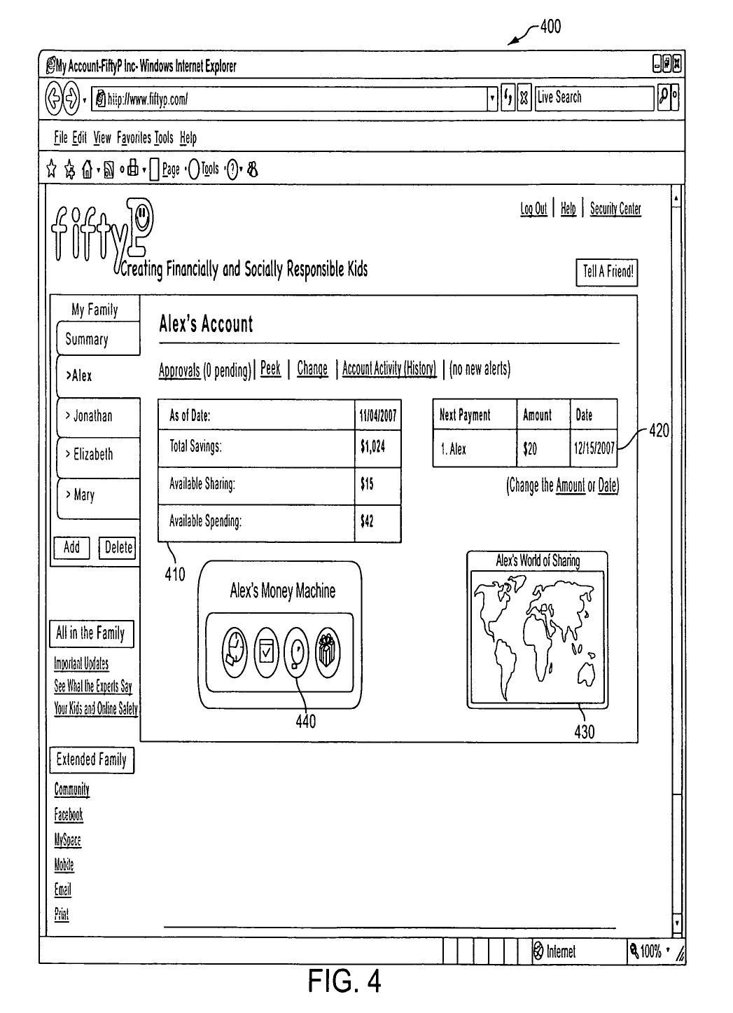

Selecting a particular child's name may direct the parent to more detailed information about the child's account. FIG. 4 is an example of an interface 400 providing additional details about Alex's account. Interface 400 provides a summary of all of Alex's accounts, as depicted at 410, and a schedule of when Alex's next payments are due, as depicted at 420. Interface 400 may also provide a link 430 to detailed information regarding Alex's sharing activities.

Interface 400 may also provide a link to Alex's Money Manager, as depicted at 440. As described herein, children may earn money in a variety of ways, including allowances, allowances tied to chores, special projects, and gifts. The Money Manager provides a tool wherein parents can make payments as the child earns money. As depicted at 440, a parent can choose one of the icons, and be directed to interfaces which enable the parent to schedule and make payments to the child's account. The amounts, timing and terms of these payments may be predicated upon the way in which this money was earned by or gifted to the child.

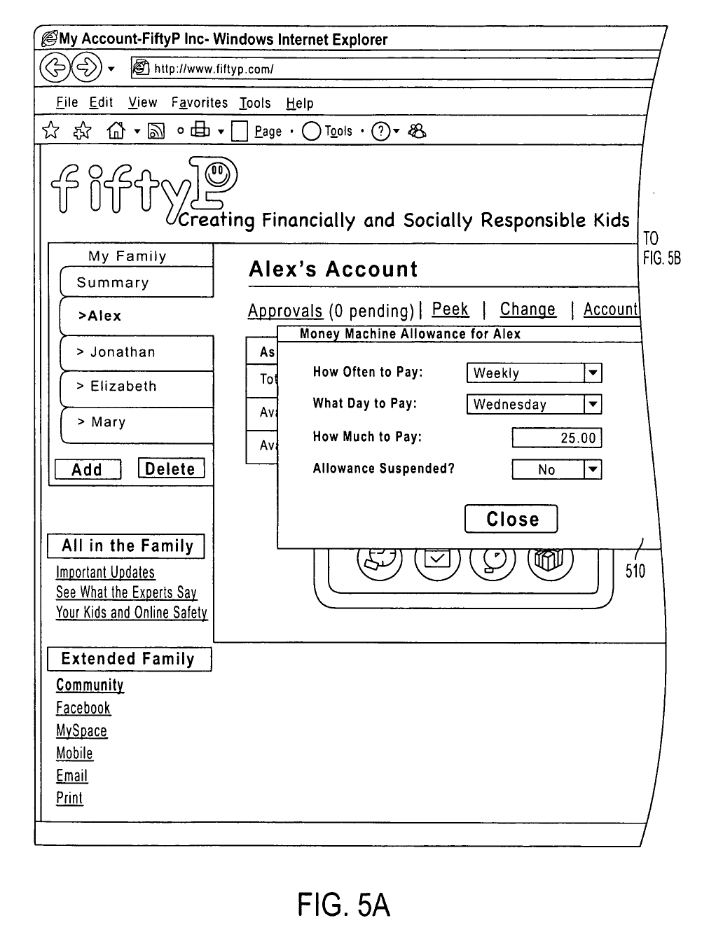

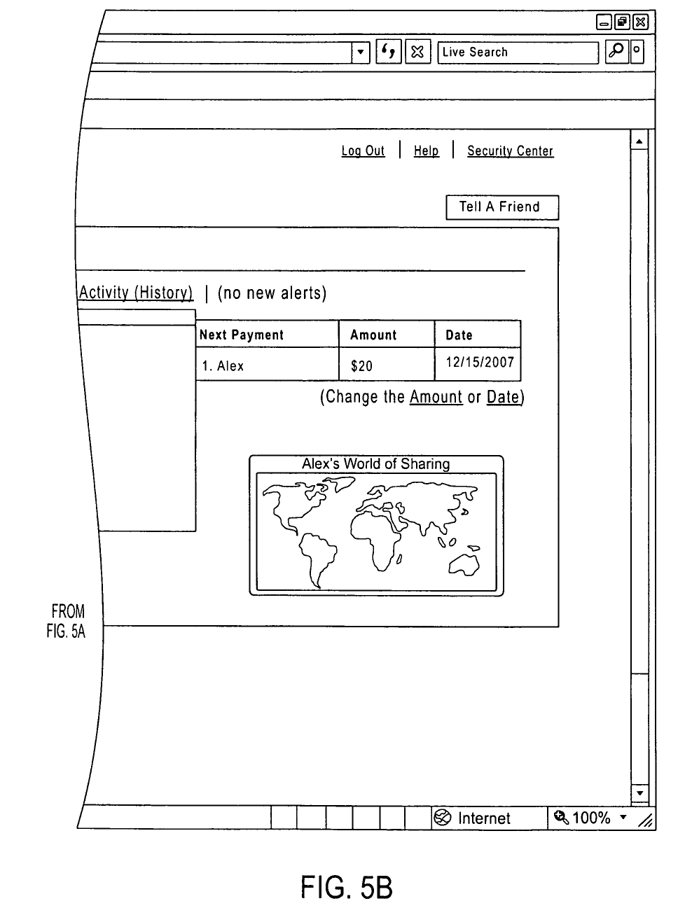

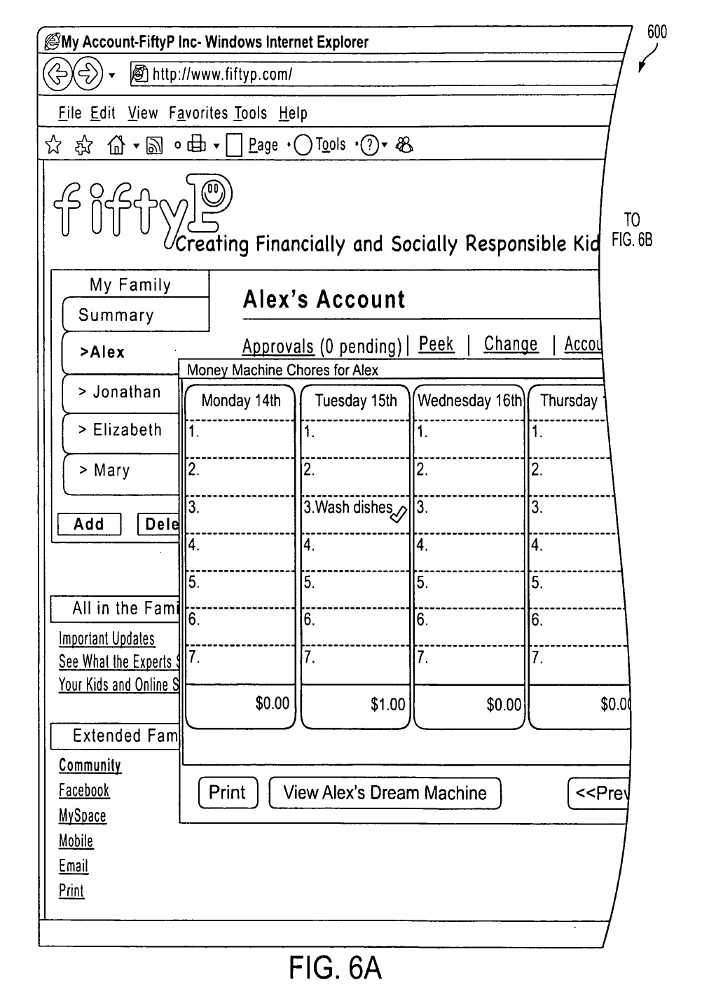

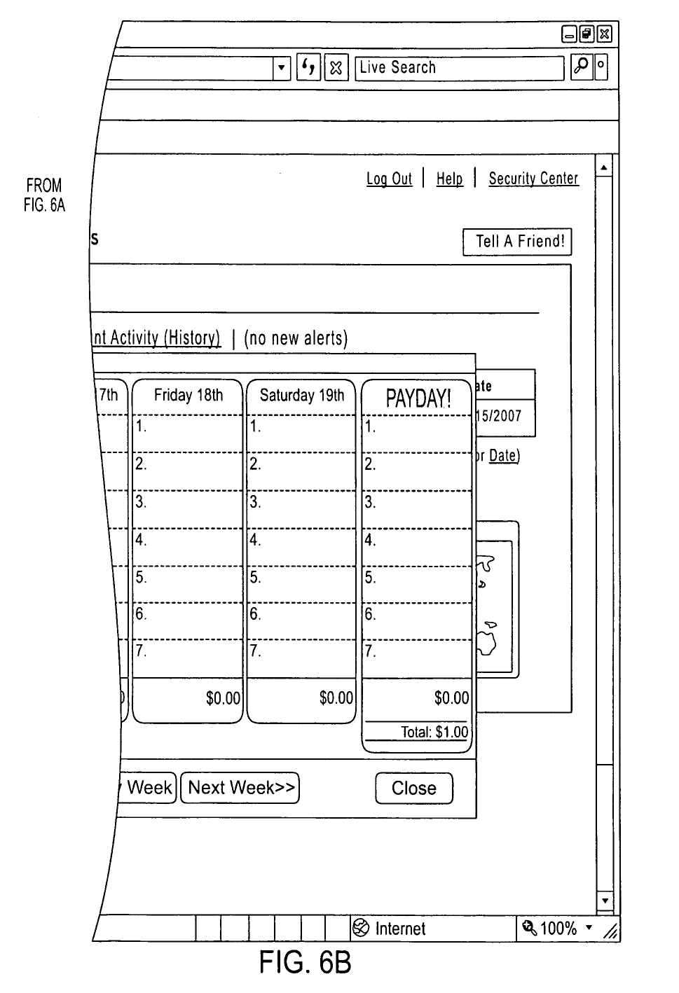

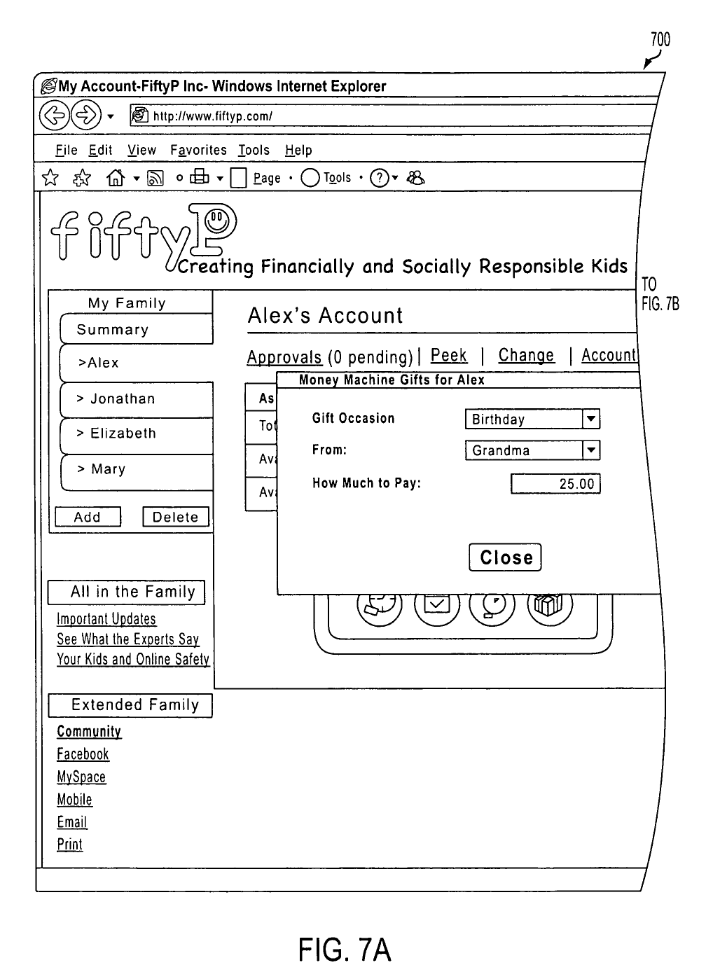

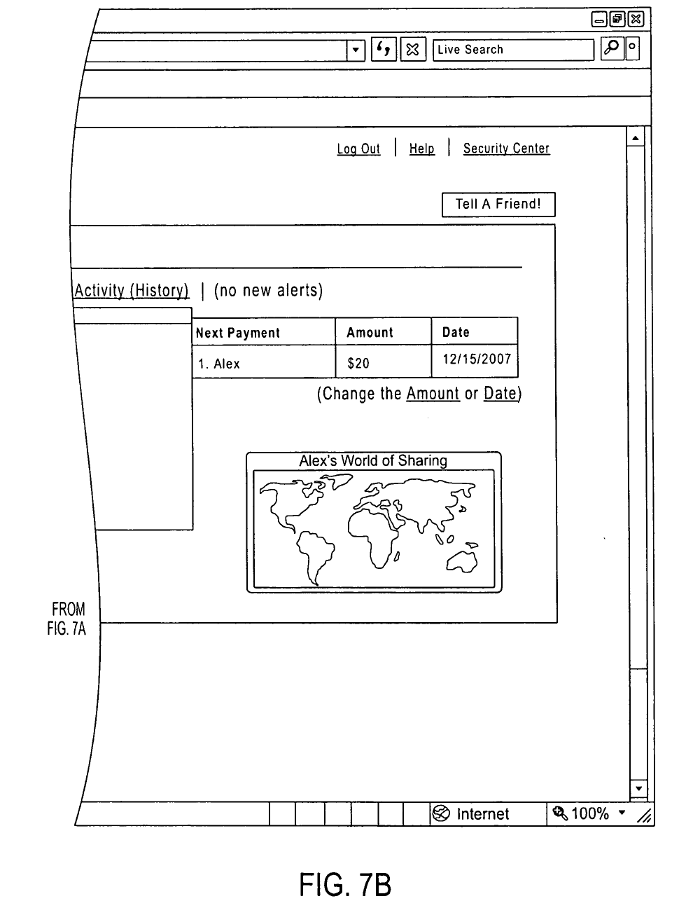

In accordance with some embodiments, selecting one of the Money Management icons may bring up a pop-up window. As depicted in FIG. 5, choosing the allowance icon brings up a pop-up window 510, which enables the parent to schedule the frequency, day of the week, and amount of allowance to be paid to Alex. The parent can also suspend allowance for a period. Other options may also be provided. Selecting the icon for allowance tied to chores may direct the parent to an interface which allows chores to be scheduled. As depicted in FIG. 6, a parent can enter chores to be performed, and the amount of money to be earned by performing the chores. A monitoring mechanism may also employed where the parent can approve a chore and its payment, ask that a chore be redone to receive payment, or deny payment in the event a chore was not completed. A similar interface may be provided for assigning special projects. A child may also earn money through gifts from family, friends or others (for example corporate entities). As depicted in FIG. 7, a parent can enter the amount of the gift, the source of the gift, and the occasion. Other information may also be entered, such as, for example, the date on which the gift was given. It is noted that while pop-up windows are depicted in FIGS. 5-7, other methods of displaying the information may be used such as, for example, opening a new interface.

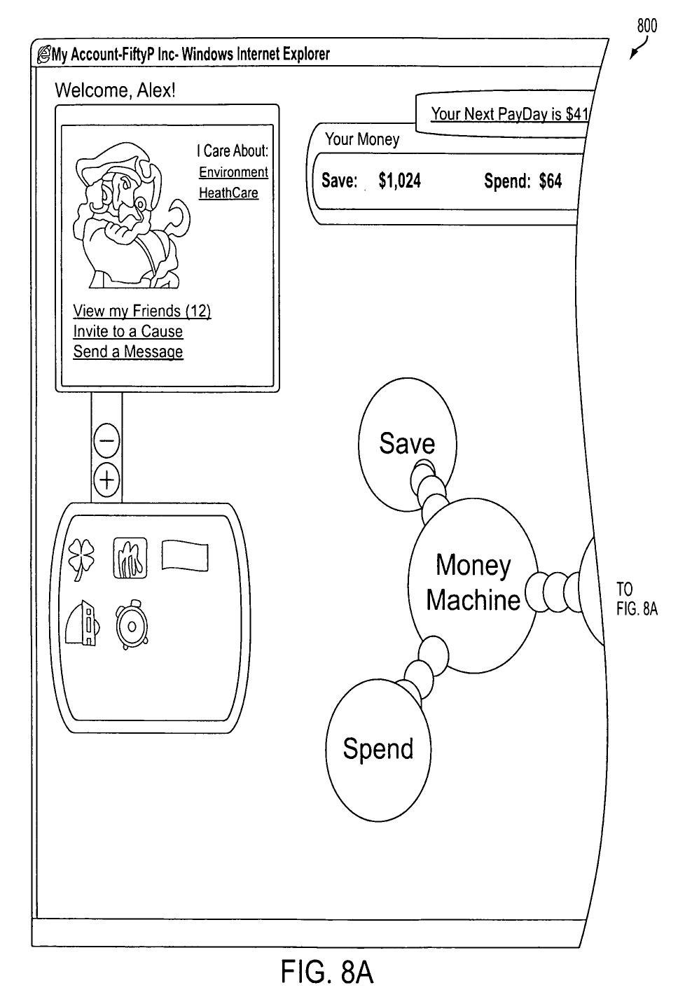

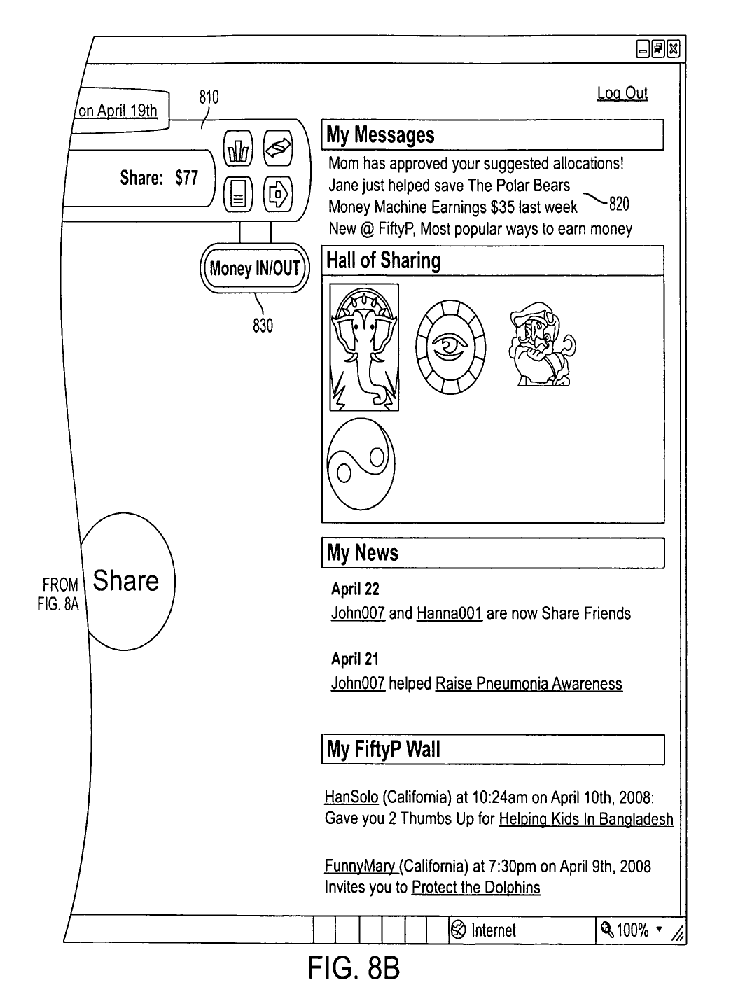

FIG. 8 depicts a child access account interface 800. As depicted at 810, the child is provided with a quick view of the amount of money available in the child's save, spend, and share accounts. Messages may also be sent to the child via their access account, as depicted at 820. Many children today participate in social networking sites. In accordance with some embodiments, a social networking component may be integrated into the money management system described herein.

Detailed information about the child's account may be accessed by selecting the appropriate icon. The child may select the save, spend, or share icon to retrieve details about each of these sub-accounts. For example, selecting share may direct the child to an interface for viewing their past sharing data as well as for making requests to make further sharing donations. Selecting spend may direct the child to an electronic storefront which enables the child to make purchases online, including the purchase of gift cards and/or full e-commerce transactions and/or pre-paid debit cards, and/or debit/ATM cards. Selecting save may direct the child to an interface to view their current investment portfolio, make changes to their existing portfolio, or make new investments.

Child access account interface 800 may also include a “MoneyIn/MoneyOut” button 830. Selecting this button may provide the child with a fully comprehensive, transparent and tagged view of all sources and uses of funds in any of the child's accounts in the system. For example, the child may be able to view information about the origin of all money earned, how savings money has been invested, how savings money has performed, where spending and sharing money goes, and/or other detailed tracking information.

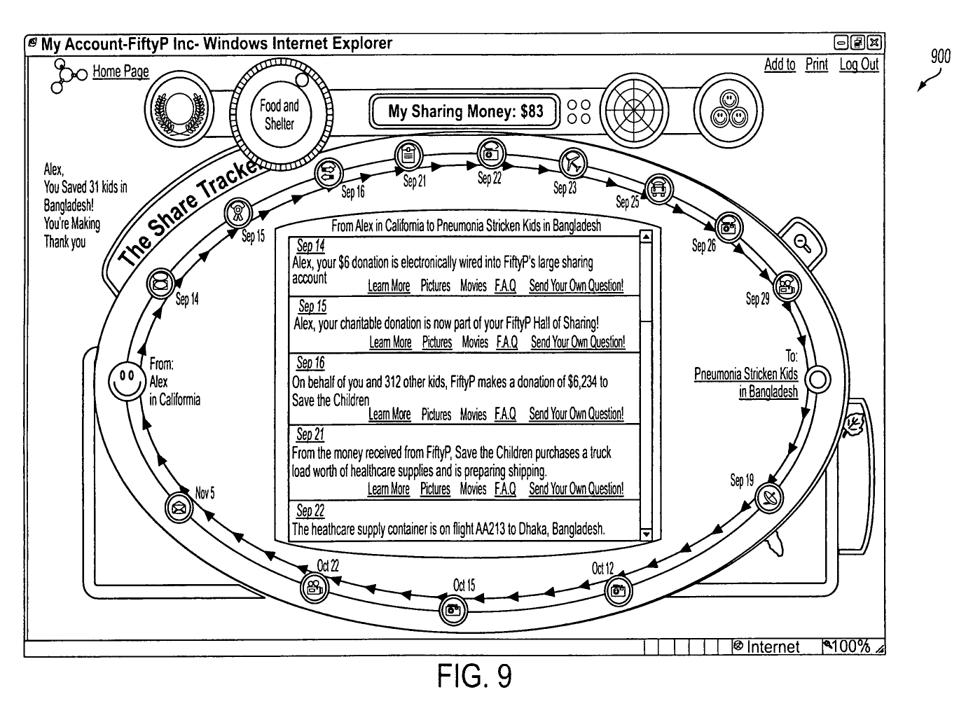

In accordance with some embodiments, a share tracker may be provided which allows the child to visualize the entire process of contributing money to a charity and the impact this contributed money may have toward a cause of interest to the child/family. FIG. 9 depicts a share tracker interface 900. In the example depicted in FIG. 9, Alex has made a $6.00 donation to pneumonia stricken kids in Bangladesh. The share tracker 900 provides Alex with a detailed description of when and how the money was employed, as well as the impact this amount of money may have had toward the cause of interest to Alex.

The processes and methods described herein may be implemented in hard-wired devices, firmware, or software running on a processor. Any of these processes may be contained on a computer readable medium. A computer readable medium may be any medium capable of carrying instructions to be performed by a microprocessor, including a CD disc, DVD disc, magnetic or optical disc, tape, silicon based removable or non-removable memory, packetized or non-packetized wireline or wireless transmission signals. Those of skill in the art will appreciate that a computer readable medium may carry instructions for a computer to perform the methods described herein.

The previous description of the disclosed embodiments is provided to enable any person skilled in the art to make or use the present invention. Various modifications to these embodiments will be readily apparent to those skilled in the art, and the generic principles defined herein may be applied to other embodiments without departing from the spirit or scope of the invention. It is noted that the particular user interfaces are merely exemplary of the type of information which may be displayed. Other information may be displayed. Thus, the present invention is not intended to be limited to the embodiments shown herein, but is to be accorded the full scope consistent with the claims.

What is claimed is:

1. A computer-implemented method for facilitating online money management comprising:
receiving, at a host computer, a request by a parent or guardian to create a parent account;
receiving, at said host computer, a request to create one or more child accounts linked to the parent account, each child account being subdivided into three or more sub-accounts,
wherein money deposited into each child account is allocated to each of the three or more sub-accounts according to a percentage allocation provided by the parent/guardian or the child.

2. The computer-implemented method of claim 1, wherein creating a parent account includes opening a financial account with a financial services partner.

3. The computer-implemented method of claim 1, wherein account information associated with a credit card, PayPal account, an existing banking account, or a new bank account is collected from the parent, the account information being used to fund transactions made by one or more of the parent's children.

4. The computer-implemented method of claim 1, wherein at least one of the three or more sub-accounts comprises a sharing account, and wherein money deposited into sharing account is designated for contributing to one or more charities.

5. The computer-implemented method of claim 1, wherein upon creation of a child account, a percentage of any profit or revenue generated is deposited into to one or more of the children's sub-accounts.

6. The computer-implemented method of claim 1, wherein the parent account includes three or more sub-accounts, and a percentage of the profit or revenue generated by opening of the parent and child accounts is deposited to one or more of the parent's sub-accounts.

7. The computer-implemented method of claim 1, wherein a percentage of profits or revenue generated are deposited to each child or parent account regularly, on a pre-scheduled basis.

8. The computer-implemented method of claim 1, wherein money deposited to each child account or sub-account is virtually deposited.

9. The computer-implemented method of claim 8, further comprising:
receiving a request from a child to make a spending or sharing transaction;
debiting, from a financial account associated with the parent, the money needed to fund the spending or sharing transaction; and
virtually debiting the money needed to fund the spending or sharing transaction from the child's account.

10. The computer-implemented method of claim 8, wherein each virtual deposit is allocated to each of the three or more sub-accounts based on the percentage provided by the parent, guardian, or child.

11. The computer-implemented method of claim 1, wherein the origin and destination of each deposit, transfer, and withdrawal from any parent or child account is tagged by the host.

12. The computer-implemented method of claim 1, wherein the sub-accounts include a savings account, a sharing account and a spending account.

13. The computer-implemented method of claim 1, wherein upon creation of a child account, a graphical user interface is provided which enables the child to login and make account transactions.

14. The computer-implemented method of claim 13, wherein the graphical user interface includes:
one or more links to make purchases from one or more vendors;
one or more links to select and make or direct a donation to a charity; and
one or more links to make savings or investment decisions.

15. A system for online money management comprising:
a parental control module configured to create a parent account and one or more child accounts;
and a child account management module providing an interface to each of said one or more child accounts; and
a financial management module for processing deposits, transfers, and withdrawals for each of said one or more child accounts, wherein
each of said one or more child accounts includes a savings sub-account, a sharing sub-account, and a spending sub-account.

16. The system of claim 15, wherein the parental control module is further configured to provide an interface for administering each of said one or more child accounts.

17. The system of claim 15, wherein said financial management module makes virtual deposits into the one or more child accounts.

18. The system of claim 15, wherein the financial management module is configured to open a bank account with a banking partner for each parent.

19. The system of claim 18, wherein the financial management module is further configured to open a bank account with a banking partner for each child.

20. A computer-implemented method for facilitating online money management, comprising:
receiving, at a host computer, a request to create an account, said account including three or more sub-accounts,
wherein deposits to said account are allocated to each of the three or more sub-accounts according to a percentage allocation.

21. The computer-implemented method of claim 20, wherein a percentage of all profit or revenue generated as a result of the creation of the account is deposited into one or more of the three or more sub-accounts.
